(19) United States
(12) Patent Application Publication
(10) Pub. No.: US 2025/0388061 A1
(43) Pub. Date: Dec. 25, 2025

(54) VEHICLE HEATING DEVICE

(71) Applicant: TOYODA GOSEI CO., LTD., Kiyosu-shi (JP)

(72) Inventors: Shota HASHIZUME, Kiyosu-shi (JP); Nobuhiro TERAI, Kiyosu-shi (JP); Toshihiko KAJIYAMA, Kiyosu-shi (JP)

(21) Appl. No.: 19/234,471

(22) Filed: Jun. 11, 2025

(30) Foreign Application Priority Data
Jun. 19, 2024 (JP) 2024-098906

(51) Int. Cl. B60H 1/22

(52) U.S. Cl. CPC B60H 1/2227; B60H 1/2226

(57) ABSTRACT

A vehicle heating device includes a heater, a case, and a lid. The heater uses radiant heat for heating. The case includes an end wall that faces a back surface of the heater and a peripheral wall. The lid is arranged in a location that faces a front surface of the heater. The case and the lid are arranged so that an air layer extends between them. The end wall includes a porous member and a plate. The porous member contacts the back surface of the heater. The plate is formed by a molded resin product contacting a surface of porous member opposite the heater.

### CROSS-REFERENCE TO RELATED APPLICATIONS

This application is based upon and claims the benefit of priority from Japanese Patent Application No. 2024-098906, filed on Jun. 19, 2024, the entire contents of which are incorporated herein by reference.

### BACKGROUND

### 1. Field

The following description relates to a vehicle heating device.

### 2. Description of Related Art

Japanese Laid-Open Patent Publication No. 2015-145182 discloses a vehicle heating device that uses radiant heat for heating.

It is desirable that the heating efficiency be improved in a vehicle heating device that uses radiant heat for heating.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a heating device includes a heating device configured to be attached to an interior component of a vehicle. A heater uses radiant heat for heating. The heater includes a surface facing a passenger compartment and defines a front surface of the heater. The heater includes a surface at a side opposite to the surface facing the passenger compartment and is defined as a back surface of the heater. A case accommodates the heater and includes an end wall facing the back surface of the heater, and a peripheral wall. A lid is arranged facing the front surface of the heater. The case and the lid are arranged so that an air layer extends between the heater and the lid. The end wall includes a porous member contacting the back surface of the heater. A plate is formed by a molded resin product covering a surface of the porous member opposite the heater.

Other features and aspects will be apparent from the following detailed description, the drawings, and the claims.

### BRIEF DESCRIPTION OF THE DRAWINGS

FIG. 1 is a schematic view of a vehicle that includes a vehicle heating device in accordance with one embodiment.

FIG. 2 is a plan view of the vehicle heating device of FIG. 1.

FIG. 3 is a cross-sectional view taken along line 3-3 in FIG. 2.

FIG. 4 is a cross-sectional view taken along line 4-4 in FIG. 2.

FIG. 5 is a cross-sectional view showing a modified example of the vehicle heating device.

FIG. 6 is a cross-sectional view showing another modified example of the vehicle heating device.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

One embodiment of a vehicle heating device will now be described with reference to the drawings.

In the description hereafter, the direction in which a vehicle travels forward is referred to as the front, and the reverse direction is hereinafter referred to as the rear. Moreover, the left-right direction refers to a vehicle width direction that corresponds to the left-right direction when the vehicle is traveling forward.

### Vehicle and Heating Device

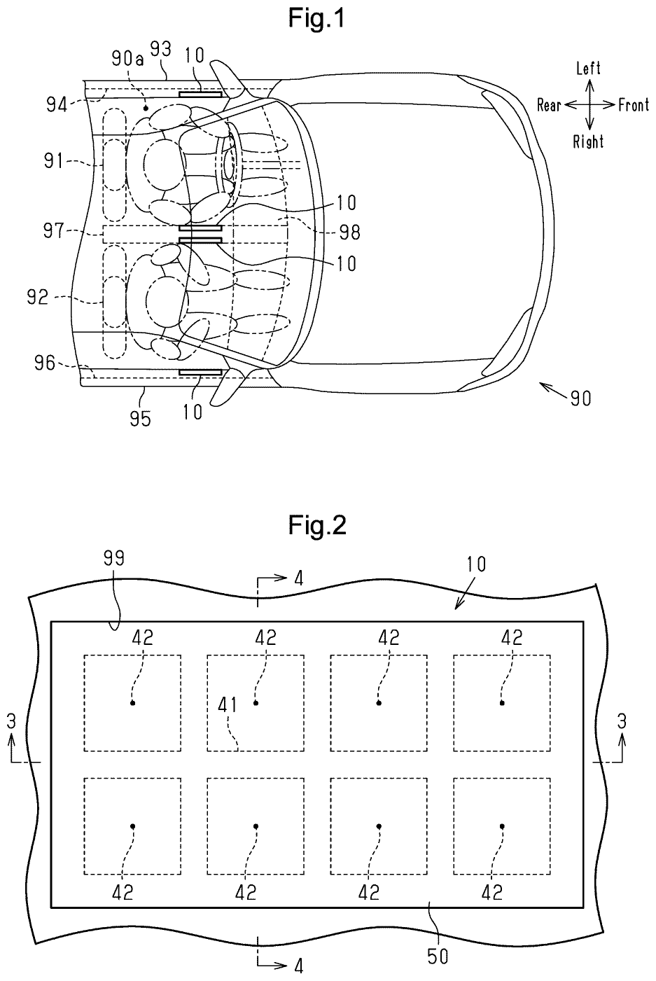

As shown in FIG. 1, a heating device 10, which is an embodiment of a vehicle heating device, is configured to be attached to an interior component of a vehicle 90. The heating device 10, as will be described below, uses radiant heat to perform heating. In the present embodiment, multiple heating devices 10 are attached to the interior components of the vehicle 90.

As shown in FIG. 1, a passenger compartment 90a of the vehicle 90 includes a first seat 91 and a second seat 92 that are front seats and are arranged in a vehicle width direction. The first seat 91 is a front left seat of the vehicle 90 and the second seat 92 is a front right seat of the vehicle 90. A center console 97 is arranged between the first seat 91 and the second seat 92 in the passenger compartment 90a. The center console 97 may also be referred to as a console box or a floor console. An instrument panel 98 is arranged frontward from the first seat 91 and the second seat 92. A front left door 93 of the vehicle 90 includes a first door trim 94 that faces the first seat 91. A front right door 95 of the vehicle 90 includes a second door trim 96 that faces the second seat 92.

As shown in FIG. 1, the heating device 10, for example, may be attached to the center console 97 of the vehicle 90. There is particularly no limitation to the subject heated by the heating device 10. For example, the heating device 10 may be arranged to radiate heat toward the thighs of a seated vehicle occupant. The heating device 10 may be arranged to radiate heat toward the shins of a seated vehicle occupant.

The number of heating devices 10 arranged in the vehicle 90 is not limited. One heating device 10 may be arranged in the vehicle 90. As another option, two or more heating devices 10 may be arranged in the vehicle 90.

When arranging the heating device 10 on the center console 97, the following arrangement of the heating device 10 is preferred. For example, as shown in FIG. 1, a heating device 10 may be arranged on a surface of the center console 97 that faces the first seat 91. A further heating device 10 may be arranged on the first door trim 94. As shown in FIG. 1, a heating device 10 may also be arranged on a surface of the center console 97 facing the second seat 92. Furthermore, a heating device 10 may be arranged on the second door trim 96.

The center console 97, the first door trim 94, the second door trim 96, and the instrument panel 98 are examples of interior components of the vehicle 90. As long as the heating device 10 is arranged in an interior component of the vehicle 90, the location of the heating device 10 is not particularly limited. For example, the heating device 10 may be arranged at a location where heat can be radiated toward a vehicle occupant seated on a back seat. Other examples of where the heating device 10 can be arranged include the ceiling, the back surfaces of the first seat 91 and the second seat 92, and the like.

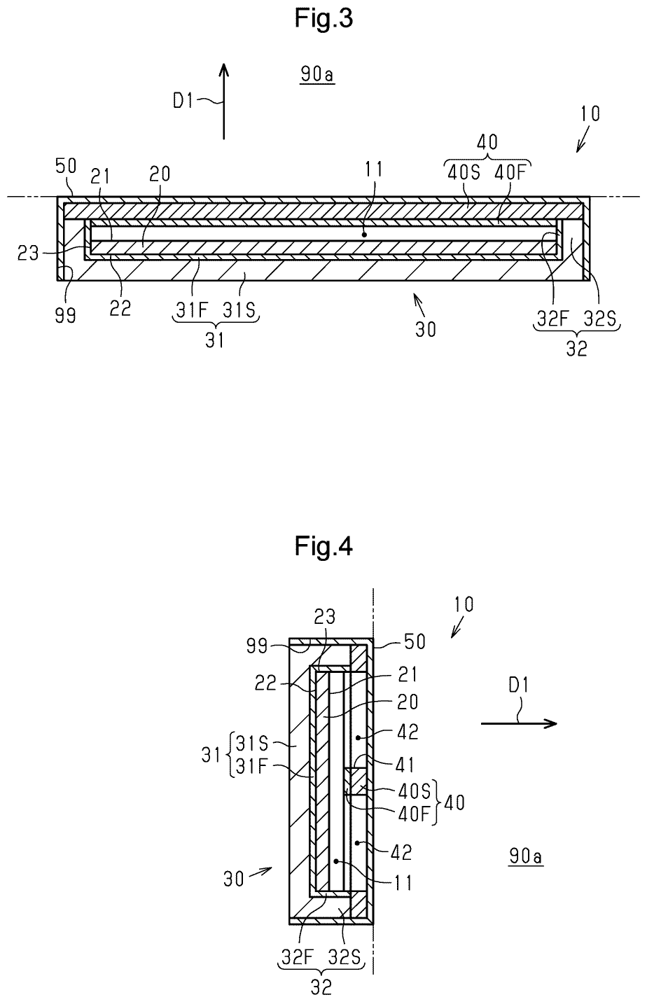

As shown in FIGS. 3 and 4, the heating device 10 includes a heater 20. The heater 20 uses radiant heat for heating. The heater 20 includes a surface facing the passenger compartment 90a that is referred to as a front surface 21 of the heater 20. Further, the heater 20 includes a surface at the opposite side of the front surface 21 that is referred to as a back surface 22 of the heater 20. The heater 20 also includes surfaces connecting the front surface 21 and the back surface 22 that are referred to as side surfaces 23.

The heating device 10 includes a case 30 that accommodates the heater 20. The heating device 10 includes a lid 40. The heating device 10 may also include a covering 50.

As shown in FIGS. 2 to 4, the heating device 10 can be attached to a holder 99 that is arranged in an interior component of the vehicle 90. An example of the holder 99 is a recess that is formed in the interior component. The heating device 10 is fitted into the holder 99, or the recess, to attach the heating device 10 to the interior component. The heating device 10 is preferably arranged so that the front surface 21 of the heater 20 is located inward from the surface of the interior component. In other words, the heating device 10 is preferably arranged farther from the passenger compartment 90a than the surface of the interior component. In an example, the heating device 10 is arranged so that the covering 50 or the lid 40 is flush with the surface of the interior component. The heating device 10 may be arranged so that the covering 50 or the lid 40 is located inward from the surface of the interior component. Alternatively, the heating device 10 may be arranged so that the covering 50 or the lid 40 projects out of the surface of the interior component toward the passenger compartment 90a.

### Heater

The heater 20 is, for example, supplied with power from a power source of the vehicle 90 to generate heat. The drawings do not show the power source and the wiring between the power source and the heating device 10.

The heater 20 is configured to radiate heat from the front surface 21. FIGS. 3 and 4 show the direction of the heat radiated from the heater 20 toward the passenger compartment 90a with the arrow depicted as heat radiation direction D1. An example of the heat radiation direction D1 is a direction orthogonal to the front surface 21 of the heater 20.

The heater 20 is for example, a planar heater. The planar heater is rectangular in plan view. Another example of the heater 20 is a rod-shaped meandering heater arranged in the plan of the front surface 21.

### Case

As shown in FIGS. 3 and 4, the case 30 includes an end wall 31 and peripheral walls 32. The case 30 is box-shaped and has an open end. The heater 20 is accommodated in the case 30 so that the front surface 21 of the heater 20 faces the open end of the case 30. The end wall 31 faces the back surface 22 of the heater 20. The peripheral walls 32 surround the side surfaces 23 of the heater 20.

### End Wall

The end wall 31 includes a first end wall layer 31 F and a second end wall layer 31S. The first end wall layer 31F contacts the back surface 22 of the heater 20. The second end wall layer 31S covers the surface of the first end wall layer 31F that is opposite the surface contacting the heater 20.

In the present embodiment, the end wall 31, which has a double-layer structure formed by the first end wall layer 31F and the second end wall layer 31S, is laminated onto the back surface 22 of the heater 20. More specifically, the first end wall layer 31F is laminated onto the entire back surface 22 of the heater 20. The second end wall layer 31S is laminated onto the entire surface of the first end wall layer 31F that is opposite the surface laminated onto the back surface 22.

The first end wall layer 31F is a porous member. The second end wall layer 31S is a plate formed by a molded resin product. Specific examples of the porous member and the plate will be described below.

### Porous Member

The porous member may be formed by for example, a fibrous body, a foamed body, or the like. As long as the porous member exhibits thermal insulation properties, there is no limitation to the material of the porous member. The fibrous body may be a nonwoven fabric, a woven fabric, or the like formed from polyester fibers, polyolefin fibers, aramid fibers, lass fibers, cellulose fibers, nylon fibers, vinylon fibers, rayon fibers, or the like. The foam body may be formed from polyethylene foam, polyurethane foam, polyolefin foam, polystyrene foam, or the like. Preferably, the porous member is formed by a foam body. Polyethylene foam is preferred as the foam body.

### Plate

The plate is formed from a material having high thermal insulation properties, such as polypropylene and polyethylene. There is no particular limitation to the method for molding the plate. Examples of such a method include injection molding, extrusion molding, and vacuum molding. In this example, the plate is not hollow. However, the plate may be hollow. The preferred plate is molded from polypropylene resin.

### Peripheral Wall

Each peripheral wall 32 includes a first peripheral wall layer 32F that contacts the side surfaces 23 of the heater 20. Each peripheral wall 32 may also include a second peripheral wall layer 32S that covers the surface of the first peripheral wall layer 32F that is opposite the surface contacting the heater 20.

In the present embodiment, each peripheral wall 32, which has a double-layer structure formed by the first peripheral wall layer 32F and the second peripheral wall layer 32S, covers the corresponding side surface 23 of the heater 20. The first peripheral wall layers 32F for example, contact the corresponding side surfaces 23, entirely. Each second peripheral wall layers 32S is laminated onto the entire surface of the first peripheral wall layer 32F that is opposite the surface contacting the corresponding side surface 23.

The first peripheral wall layer 32F is a porous member. The porous member may be formed by the same porous member exemplified as the first end wall layer 31F. The porous member that forms the first peripheral wall layer 32F may be of the same type as the porous member that forms the first end wall layer 31F or may be of different type of porous member.

When the porous member that forms the first end wall layer 31F is of the same type as the porous member that forms each first peripheral wall layer 32F, the first end wall layer 31F and the first peripheral wall layer 32F may be an integrated member or may be separate members.

Each second peripheral wall layer 32S is a plate formed by a molded resin product. The plate may be formed by the same type of plate exemplified as the second end wall layer 31S. The plate that forms the second peripheral wall layer 32S may be of the same type as the plate that forms the second end wall layer 31S or may be of a different type of plate.

When the plate that forms the second end wall layer 31S is of the same type as the plate that forms each second peripheral wall layer 32S, the second end wall layer 31S and the second peripheral wall layer 32S may be an integrated member or may be separate molded products. When the plate that forms the second end wall layer 31S is of a type differing from that of the second peripheral wall layer 32S, the second end wall layer 31S and the second peripheral wall layer 32S may be integrated through, for example, two-color molding.

### Lid

As shown in FIGS. 3 and 4, the lid 40 includes a first lid member 40S. The first lid member 40S is configured to cover the open end of the case 30.

The first lid member 40S is for example, a plate formed by a molded resin product. The plate may be formed by the same plate exemplified as the second end wall layer 31S. The plate that forms the first lid member 40S may be of the same type as the plate that forms the second end wall layers 31S or may be of a different type.

The lid 40 may include a through hole 42 that extends in the heat radiation direction D1, which is the direction extending from the heater 20 toward the passenger compartment 90a. In the example shown in FIGS. 2 and 4, the lid 40 includes eight through holes 42 and a lattice 41 formed between the through holes 42. There is particularly no limitation to the shape, the size, and the number of the through holes 42.

The lid 40 may include a second lid member 40F that is laminated onto the first lid member 40S. The second lid member 40F is for example, laminated onto a surface of the first lid member 40S that faces the heater 20. When the lid 40 includes the through holes 42, the second lid member 40F may be laminated into the first lid member 40S at the lattice 41 of the lid 40.

The second lid member 40F is for example, a porous member. The porous member of the second lid member 40F may be formed by the same porous member exemplified as the first end wall layer 31F. The porous member that forms the second lid member 40F may be of the same type as the porous member that forms the first end wall 31F or may be of a different type of porous member.

The case 30 and the lid 40 are arranged so that an air layer 11 extends between the heater 20 and the lid 40. More specifically, as shown in FIGS. 3 and 4, the lid 40 is spaced apart from the heater 20 by a predetermined distance in the heat radiation direction D1. Thus, the air layer 11 is defined by the front surface 21 of the heater, the peripheral walls 32 of the case 30, and the lid 40. When the lid 40 includes the through holes 42, the air layer 11 is connected to the through holes 42.

### Covering

The covering 50 is used for interior components. Specific examples of the covering 50 include woven fabric, nonwoven fabric, knitted fabric, resin sheet, synthetic leather, artificial leather, natural leather, or the like. The covering 50 may include a pattern for ornamental purposes or the like. The covering 50 may have a coarse mesh structure.

As shown in FIGS. 2 to 4, the lid 40 for example, may include a surface to which the covering 50 is adhered. As shown in FIG. 4, when the lid 40 includes the through holes 42, the heater 20 faces the covering 50 through the air layer 11 and the through holes 42 at locations corresponding to the through hole 42.

As shown in FIGS. 3 and 4, the peripheral walls 32 for example, may each include a surface to which the covering 50 is adhered.

The covering 50 may be of the same type as the covering of the interior component to which the heating device 10 is attached. Alternatively, the covering 50 may be of a type differing from the covering of the interior component to which the heating device 10 is attached. The surface of the lid 40 may be adhered with the covering 50 that is integrated with the covering of the interior component including the holder 99.

### Operation of Present Embodiment

When the heating device 10 is activated, the heater 20 generates heat. The generated heat is radiated from the front surface 21 of the heater 20. The radiant heat is radiated toward an occupant of the vehicle 90 through the lid 40 and the covering 50. In this case, the air layer 11 extending between the lid 40, which faces the front surface 21 of the heater 20, and the heater 20 limits temperature increases of the lid 40 as compared with when the heater 20 directly contacts the lid 40.

The heat generated by the heater 20 in addition with the radiant heat from the front surface 21 are radiated to the surrounding members of the heater 20. In the present embodiment, the heating device 10 includes the end wall 31 which is in contact with the back surface 22 of the heater 20. The end wall 31 has thermal insulation properties. This limits heat radiation in a direction opposite to the direction extending from the heater 20 toward the passenger compartment 90a. Furthermore, the peripheral walls 32, which surrounds the side surfaces 23 of the heater 20, have thermal insulation properties. This limits heat radiation in the direction orthogonal to the direction extending from the heater 20 toward the passenger compartment 90a.

### Advantages of Present Embodiment

(1) In the present embodiment, the end wall 31, which has a double-layer structure formed by the porous member and the plate, allows the end wall 31 to have high thermal insulation properties. This limits heat radiation in the direction opposite to the direction extending from the heater 20 toward the passenger compartment 90a. Thus, heat loss of the heater 20 is reduced, and heating efficiency is thus improved.
(2) The air layer 11 extending between the heater 20 and the lid 40 avoids a situation in which the temperature of the lid 40 becomes excessively high, as compared with when the heater 20 directly contacts the lid 40. Thus, even if the vehicle occupant touches the lid 40, the heat of the lid 40 perceived by the vehicle occupant will be reduced. In the present embodiment, the heat perceived by the vehicle occupant when touching the lid 40 is reduced without using a structure that detects when the vehicle occupant touches the lid 40, and a processor that reduces the heater output when the vehicle occupant touches the lid 40.
(3) When each peripheral wall 32 has a double-layer structure formed by the porous member and the plate, heat radiation is limited in the direction orthogonal to the direction extending from the heater 20 toward the passenger compartment 90a. The end wall 31, which contacts the back surface 22 of the heater 20, and the peripheral walls 32, which surround the side surfaces 23, further reduce heat loss of the heater 20. This further improves heat efficiency.
(4) When the lid 40 includes the through holes 42, even if the vehicle occupant touches the lid 40, the area of the lid 40 that is touched is less than when the lid 40 does not include the through holes 42. Therefore, even if the occupant of the vehicle 90 touches the lid 40, the heat perceived by the vehicle occupant is reduced. If the vehicle occupant touches a location corresponding to the through holes 42, the vehicle occupant will be touching only the covering 50 and not the lid 40. Moreover, in the present embodiment, the air layer 11 extends between the heater 20 and the lid 40. Thus, even if the vehicle occupant touches a location corresponding to the through holes 42 with a finger or the like, the air layer 11 will result in the heater 20 being difficult to reach with the finger. Therefore, this prevents the vehicle occupant from touching the heater 20.
(5) When the heater is a planar heater, heat is efficiently radiated toward the passenger compartment 90a.
(6) When the heating device 10 of the present embodiment is attached to the center console 97, the heating device 10 is arranged closer to the vehicle occupant than when the heating device 10 is attached to the instrument panel 98. In this manner, when the distance between the heating device 10 and the vehicle occupant is short, even if the output of the heater 20 is decreased, the vehicle occupant can readily perceive the heating effect. The heating device 10 of the present embodiment has low heat loss. Thus, even if the output of the heater 20 is low, heating can be efficiently performed.

When the distance between the heating device 10 and the vehicle occupant is short, the vehicle occupant may easily touch the lid 40. In this respect, in the heating device 10 of the present embodiment, the temperature of the lid 40 will not become excessively high temperature. This ensures the safety of the vehicle occupant.
(7) When the heating devices 10 are arranged so that the vehicle occupant is sandwiched between two heating devices 10, for example when a heating device 10 is attached to the center console 97 and another heating device 10 is attached to the first door trim 94, the occupant of the vehicle 90 can be warmed from two sides in the vehicle width direction. In this structure, the vehicle occupant can perceive the heating effect more readily.

### Modifications

The above-described embodiment may be modified as follows. The above-described embodiment and the following modifications can be combined as long as the combined modifications remain technically consistent with each other.

In the present embodiment, the end wall 31 is exemplified as the double-layer structure formed by the first end wall layer 31F and the second end wall layer 31S. The end wall is not limited to the double-layer structure. The end wall may be a multi-layer structure of three or more layers. For example, the second end wall layer 31S may include a surface onto which the first end wall layer 31F is laminated and an opposite surface onto which another different plate or the like is laminated. In the same manner, each peripheral wall may be a multi-layer structure with three or more layers.

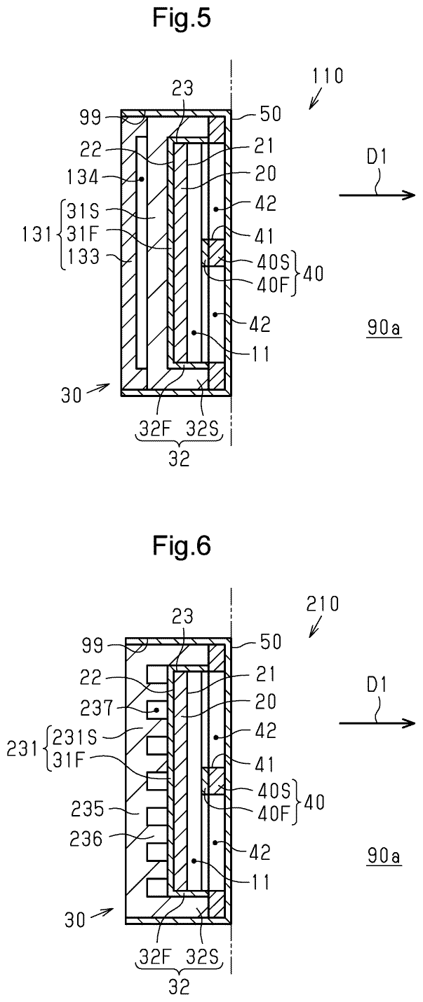

The end wall may include space therein. An example will be described with reference to FIG. 5.

FIG. 5 shows a heating device 110. In the heating device 110, same reference numbers are given to those elements that are the same as the above embodiment. Such elements will not be described in detail.

The heating device 110 includes a third end wall layer 133. The third end wall layer 133 is for example, a plate formed by a molded resin product. The third end wall layer 133 is attached to the second end wall layer 31S. More specifically, the third end wall layer 133 is attached to the surface of the second end wall layer 31S that is opposite the surface onto which the first end wall layer 31F is laminated. The third end wall layer 133 includes a surface that faces the second end wall layer 31S. The surface of the third end wall layer 133 that faces the second end wall layer 31S includes a recess. The recess results in an end wall of the third end wall layer 133 being located at a position spaced apart from the second end wall layer 31S in a direction opposite the heat radiation direction D1. Therefore, as shown in FIG. 5, a rear air layer 134 is defined between the third end wall layer 133 and the second end wall layer 31S. For example, the rear air layer 134 is an enclosed space extending between the third end wall layer 133 and the second end wall layer 31S.

In the above modification, the heating device 110 is exemplified as a structure that includes the rear air layer 134 defined by the third end wall layer 133. A different structure may also provide space in the heater 20 at a position located in the opposite direction of heat radiation direction D1. An example will now be described with reference to FIG. 6.

As shown in FIG. 6, a second end wall layer 231S includes a wall portion 235 and a protrusion 236. The wall portion 235 covers the surface of the first end wall layer 31F that is opposite the surface contacting the heater 20. The protrusion 236 projects from the wall portion 235 towards the first end wall layer 31F. The protrusion 236 includes an end that faces the first end wall layer 31F and contacts the first end wall layer 31F.

The second end wall layer 231S preferably includes multiple protrusions 236. Preferably, the multiple protrusions 236 are arranged at intervals. In this structure, small openings 237 are defined by each adjacent protrusion 236, adjacent protrusions 236, the peripheral walls 32, and the wall portion 235 and the first end wall layer 31F. Thus, the small openings 237 are defined in the end wall 231. For example, each small opening 237 is an enclosed space extending between the second end wall layer 231S and the first end wall layer 31F. The small openings 237 may be connected to one another or be independent from one another.

Additionally, when the second end wall layer 231S includes the multiple protrusions 236, the protrusions 236 may have the same shape and size or different shapes and sizes. Nevertheless, the protrusions 236 projecting from the wall portion 235 preferably have the same length.

In a heating device 210, in the same manner as the rear air layer 134 of the heating device 110, the small openings 237 are arranged in the heater 20 in the direction opposite of the heat radiation direction D1. Thus, in the same manner as the heating device 110, heat radiated from the heater 20 in the direction opposite the heat radiation direction D1 is further reduced.

Furthermore, in the heating device 210, each protrusion 236 is in contact with the first end wall layer 31F. In this structure, in the same manner as the above embodiment, compared to when the second end wall layer 31S is laminated onto the entire surface of the first end wall layer 31F, the contact area of the second end wall layer 231S and the first end wall layer 31F is reduced. Therefore, heat radiation from the heater 20 toward the direction opposite of heat radiation direction D1 can be further reduced.

An end wall that includes space defined therein may be formed from a plate having a hollow structure, such as a corrugated plastic. For example, a porous member, a hollow plate formed by resin molded product, and a solid plate formed by resin molded product may be sequentially laminated onto the back surface 22 of the heater 20.

Space may be defined in each peripheral wall of a case. For example, space may be defined in an end wall and a peripheral wall. Alternatively, space may be defined in one of an end wall and a peripheral wall.

In the present embodiment, the case 30 and lid 40 are separate members. However, the lid and the peripheral walls may be molded integrally. In this case, the end wall may be a molded product that is separate from the molded product of the lid and the peripheral walls.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A heating device, comprising:
a heating device configured to be attached to an interior component of a vehicle;
a heater using radiant heat for heating, the heater including:
a surface facing a passenger compartment and defining a front surface of the heater; and
a surface at a side opposite to the surface facing the passenger compartment and defining a back surface of the heater;
a case accommodating the heater and including an end wall, facing the back surface of the heater, and a peripheral wall; and
a lid arranged so as to face the front surface of the heater, wherein the case and the lid are arranged so that an air layer extends between the heater and the lid, and
the end wall includes
a porous member contacting the back surface of the heater, and
a plate formed by a molded resin product covering a surface of the porous member opposite the heater.

2. The heating device according to claim 1, wherein
the heater includes a side surface that connects the front surface and the back surface, and
the peripheral wall includes
a porous member contacting the side surface of the heater, and
a plate formed by a molded resin product covering a surface of porous member opposite the heater.

3. The heating device according to claim 1, wherein the lid includes a through hole extending therethrough in a direction extending from the heater towards the passenger compartment.

4. The heating device according to claim 1, wherein the heater is a planar heater.

5. The heating device according to claim 1, wherein the end wall includes a space therein.
